(19) United States
(12) Patent Application Publication
(10) Pub. No.: US 2009/0114037 A1
(43) Pub. Date: May 7, 2009

(54) Photo-Acoustic Flow Meter

(76) Inventor: Mark Forrest Smith, Longmont, CO (US)

Correspondence Address: PATENTMETRIX, 14252 CULVER DR. BOX 914, IRVINE, CA, 92604, US

(21) Appl. No.: 12/249,090

(22) Filed: Oct. 10, 2008

Related U.S. Application Data
(60) Provisional application No. 60/979,113, filed on Oct. 11, 2007.

(51) Int. Cl. G01F 1/66

(52) U.S. Cl. 73/861.28

(57) ABSTRACT

A photo-acoustic flow meter for use in dialysis is described, that uses an optical beam to generate an acoustic signal in the fluid for which the flow rate is to be measured. The phase angle of the acoustic signal changes when traversing upstream and when traversing downstream. The phase difference between the acoustic signals received upstream and downstream, compared with a reference source signal is measured, and it yields the flow rate of the fluid.

### CROSS-REFERENCE

The present invention relies upon U.S. Patent Provisional Application No. 60/979,113, filed on Oct. 11, 2007, for priority.

### FIELD OF THE INVENTION

The present invention generally relates to the field of systems and methods for fluid flow rate measurement, and, more specifically, to a non-invasive acoustic fluid flow meter.

### BACKGROUND OF THE INVENTION

Acoustic fluid flow meters operate based upon the principle that the propagation velocity of an acoustic wave in a fluid is a) equal to the acoustic velocity with respect to the fluid plus the velocity of the fluid in the direction of the flow and b) equal to the acoustic velocity with respect to the fluid minus the velocity of the fluid in the direction opposite to the direction of flow of the fluid. Typically, prior art acoustic flow meters include a pair of acoustic transducers each adapted for generating and detecting an acoustic pressure wave in a fluid, the velocity of which is to be measured. The transducers, which are positioned to define a communication link between them along the direction of fluid flow, transmit acoustic waves in alternate directions across the link while measuring the acoustic propagation period, also referred to as the acoustic time of flight, in both the upstream and the downstream directions. Differences between the upstream and downstream propagation periods are measured and used to determine the fluid velocity or fluid flow rate.

U.S. Pat. No. 3,894,431 to Muston, et al discloses determining fluid flow rates “by transmitting ultrasonic pulses in both directions along a path through the fluid aligned with the direction in which velocity component is to be measured. Transmission of, and measurement upon, pulses in the two directions are controlled by a master clock pulse generator. The frequency of a first variable frequency oscillator is adjusted to fit N pulses exactly into the timer period for flight of an ultrasonic pulse along the path in one direction. The frequency of a second variable frequency oscillator is adjusted to fit N pulses exactly into the time period for flight of an ultrasonic pulse along the path in the opposite direction. The difference frequency is proportional to velocity component. This system may be combined with a limited sing-around system to improve resolution, at the expense of the time response.”

U.S. Pat. No. 4,885,942 to Magori discloses using “the phase difference method wherein two ultrasound transducers W1 and W2 are mounted offset but aligned with each other in a tube through which the velocity of flow is to be measured wherein both of the ultrasound transducers are excited in a pulse manner by an oscillator OS2 and wherein receiving amplifiers V1 and V2 are, respectively, associated with the ultrasound transducers W1 and W2. Evaluation devices are connected after amplifier V1 and V2 such that the phase relationship of the signals at the outputs of the receiving amplifiers V1 and V2 is determined during the reception of ultrasound signals. The phase relationship between the signals at the ultrasound transducers is also determined during transmission of ultrasound signals and this phase difference is used as a reference during reception of ultrasound signals.”

These aforementioned prior art flow meters are invasive; in other words, these flow meters or some mechanical parts thereof are required to be in contact with the fluid for which the flow rate is to be determined. However, non-invasive or non-contact measurement of rate of flow of a fluid is needed in applications where a contacting measurement device is likely to interfere with the fluid flow, where space around the flowing fluid is limited (such as in conduits of small diameters) and/or where foreign objects are not desirable to come in contact with the fluid. These conditions are typically true for medical applications and are particularly so in extracorporeal blood processing systems such as hemodialysis, hemofiltration and hemodiafiltration systems.

Accordingly, there is need in the art for a non-invasive or non-contact type acoustic flow meter that has improved accuracy. Also needed is a non-invasive acoustic flow meter that has the ability to generate an acoustic signal directly in the fluid to be monitored without contacting that fluid.

### SUMMARY OF THE INVENTION

In one embodiment, the present invention is directed to a method for measuring the flow of a fluid during dialysis, the method comprising projecting an optical beam into said fluid wherein said fluid flows through a fluid pathway in a disposable manifold; detecting the resultant acoustic signal at a first point upstream and at a second point downstream in the fluid; determining the phase difference between said acoustic signal detected upstream and said acoustic signal detected downstream in the fluid; and computing the rate of flow of said fluid from said determined phase difference. Optionally, the fluid is blood or dialysate. Optionally, the optical beam is generated by a laser system. Optionally, the optical beam is projected perpendicular to the direction of flow of the fluid. Optionally, the phase difference is determined by subjecting to subtraction the signals representative of said acoustic signal phase detected upstream and downstream. Optionally, the renal dialysis includes any one or a combination of hemodialysis, hemofiltration and hemodiafiltration.

In another embodiment, the present invention comprises a photo-acoustic flow meter for measuring the flow of a fluid during dialysis, the photo-acoustic flow meter comprising a fluid pathway having a transparent section therein, an optical system for projecting an optical beam into said fluid, wherein said fluid flows through said fluid pathway and wherein the optical beam is projected through said transparent section, a first acoustic detector for detecting the acoustic signal at a first point upstream from said transparent section, a second acoustic detector for detecting said acoustic signal at a second point downstream from said transparent section; means for determining the phase difference between said acoustic signal detected upstream and said acoustic signal detected downstream; and means for computing the rate of flow of said fluid from the determined phase difference.

Optionally, the means for determining the phase difference comprises a subtraction unit. The optical system is a pulsed laser system. The optical beam is projected perpendicular to the direction of flow of said fluid.

### BRIEF DESCRIPTION OF THE DRAWINGS

These and other features and advantages of the present invention will be appreciated, as they become better understood by reference to the following detailed description when considered in connection with the accompanying drawings, wherein:

FIG. 1 is a circuit diagram illustration of a photo-acoustic flow meter arrangement of the present invention;

FIG. 2a depicts a reference signal for the photo-acoustic flow meter system of the present invention;

FIG. 2b depicts acoustic signals received upstream from the optical signal application point of the photo-acoustic flow meter of the present invention; and

FIG. 2c depicts acoustic signals received downstream from the optical signal application point of the photo-acoustic flow meter of the present invention.

### DETAILED DESCRIPTION OF THE INVENTION

While the present invention may be embodied in many different forms, for the purpose of understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

The present invention is a novel non-invasive or non-contact type acoustic flow meter that has the ability to generate an acoustic signal directly in the fluid to be monitored without physical contact. The acoustic flow meter of the present invention provides flow measurement with improved accuracy, based on the measurement of acoustic wave transit time. It is further contemplated the present flow meter can be incorporated into the structure of a disposable manifold used in medical applications, particularly dialysis machines. In particular, the present flow meter can be incorporated into the manifold structures and devices disclosed in U.S. patent application Ser. No. 12/237,914, entitled Manifolds for Use in Conducting Dialysis and filed on Sep. 25, 2008, and U.S. patent application Ser. No. 12/245,397, entitled Wearable Dialysis Methods and Devices and filed on Oct. 3, 2008, which are incorporated herein by reference in their entirety. It should be appreciated that th

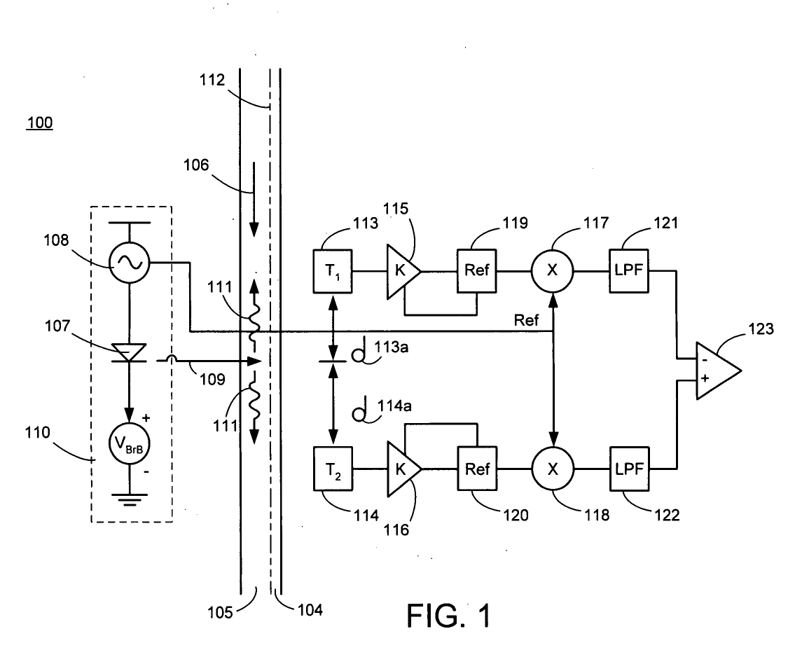

FIG. 1 is a circuit diagram depicting the photo-acoustic flow meter 100 of the present invention. The fluid 104 for which the flow rate is to be measured, is carried by a fluid-bearing passageway 105, such as a pipe or tubing, in the direction indicated by the arrow 106. The photo-acoustic pulse flow meter 100 comprises a light emitting system 110. In one embodiment, the system 110 further comprises an LED or solid state laser 107, which is excited in a sinusoidal manner by a signal source 108. In another embodiment, a Q-switched ruby laser (not shown) may be used in place of system 110. Persons of ordinary skill in the art would appreciate that any other suitable optical generation system known in the art may be used for the purpose. The optical generation system 110 projects a beam 109 into the fluid 104 through an optical aperture, or an optically transparent section (not shown) formed in the wall of the passageway 105. In one embodiment, the projected optical beam 109 traverses through the fluid 104 in a direction perpendicular to the direction of the axis 112 of the fluid-bearing passageway 105. The optically transparent section of tube 105 should be transparent to the particular wavelength of optical source 110. The wavelength of optical source 110 must be selected so that the light is readily absorbed by the fluid 104, whose flow rate the system is intended to measure. It should further be appreciated that, when the present system 100 is used with a manifold, the optical generation system 110 is preferably contained in the dialysis machine into which the disposable manifold is loaded and aligned with the manifold such that the generated optical beam 109 passes through a transparent section of the manifold.

As the optical beam 109 passes into the fluid 104, heat energy associated with the optical beam is absorbed into the fluid. The absorption of heat occurs along the direction of the beam 109 and causes thermal fluctuations in the fluid 104. These thermal fluctuations manifest as localized fluid heating and cause thermal expansion in the fluid. As a result of this thermal expansion, an acoustic signal 111 is produced. The nature of this signal, in terms of pressure variations in the fluid 104, replicate the waveform generated in signal source 108 used to power the optical signal generation element 107. This pressure variation propagates both downstream and upstream with respect to the location of the optical beam 109 in the passageway 105.

As is known to persons skilled in the art, the acoustic signals received upstream and downstream by sensors 113 and 114 respectively will be out of phase with one another. The amount of the phase difference between the acoustic signals received upstream and downstream is directly proportional to the flow rate. It should be further appreciated that, when used in conjunction with a disposable manifold, the sensors 113 and 114 are positioned proximate to the manifold tubing or embedded within the manifold tubing.

Accordingly, in one embodiment acoustic detectors T1 113 and T2 114 are placed upstream and downstream respectively, equidistant from the optical beam 109, such that d1 113a and d2 114a are equal. In another embodiment the upstream and downstream placement of 113 and 114 need NOT be equidistant from 109. Detectors T1 and T2 may be either pressure transducers or acoustic transducers such as microphones. A microphone cartridge such as Model WM-55A103 manufactured by Panasonic Corporation is suitable for this application.

The detectors T1 113 and T2 114 interrogate the fluid flow to detect the acoustic signal 111 at the points where the detectors T1 113 and T2 114 are located. Interrogation occurs acoustically as the pressure variations (sound) of acoustic signal 111 is transferred through the walls of conduit 105 to sensors 113 and 114.

A first receiving amplifier 115 is connected to the detector T1 113 and a second receiving amplifier 116 is connected to receive the output from the detector T2 114. The outputs of the first and second amplifiers 115 and 116 are connected to the inputs of first and second phase sensitive detectors 117 and 118 respectively, through gain control elements 119 and 120. One implementation of phase sensitive detectors 117 and 118 is known in the art as a “lock in amplifier”. After the signals are processed by the amplifiers 115, 116 and phase sensitive detectors 117, 118, the outputs of 117 and 118 are passed through low pass filters 121 and 122 to eliminate high frequency noise components, or ripples left over from the phase sensitive detection process, from the signals. The resultant outputs of filters 121 and 122 are steady signals representative of the relative phase, with respect to the original signal of generator 108, of the acoustic signals detected by 113 and 114 respectively. Thus, the photo-acoustic flow meter of the present invention provides an indication of the phase angle of the upstream and downstream acoustic signals, with respect to a reference signal.

After processing and phase detection by the phase sensitive detector elements, the upstream and downstream phase angle signals are supplied to addition/subtraction unit 123. The output of the addition/subtraction unit 123 represents the phase difference between the acoustic signal received upstream by the acoustic detector T1 113 and downstream by the acoustic detector T2 114. This phase difference between these acoustic signals is directly proportional to the flow rate of the fluid and, as one of ordinary skill in the art would appreciate, can be used as the basis to calculate the actual flow rate or changes to the flow rate. All means for calculating the flow rate comprise a processor and software algorithms for deriving the flow rate or changes in the flow rate, from at least the phase difference data. Therefore, the output of the addition/subtraction unit 123 provides a measurement of the flow rate of the fluid 104.

Thus, as described above, in one embodiment output voltage signals of the first and second low pass filers 121 and 122 are sampled and, in the unit 123, are subjected to a subtraction to determine a phase difference signal indicative of the rate of flow of the fluid in the passageway 105. One of ordinary skill in the art would appreciate that any other suitable means for computing the phase difference from the outputs of the acoustic detectors may be employed. All such means comprise a processor and either hard coded or soft coded software algorithms for calculating a phase difference.

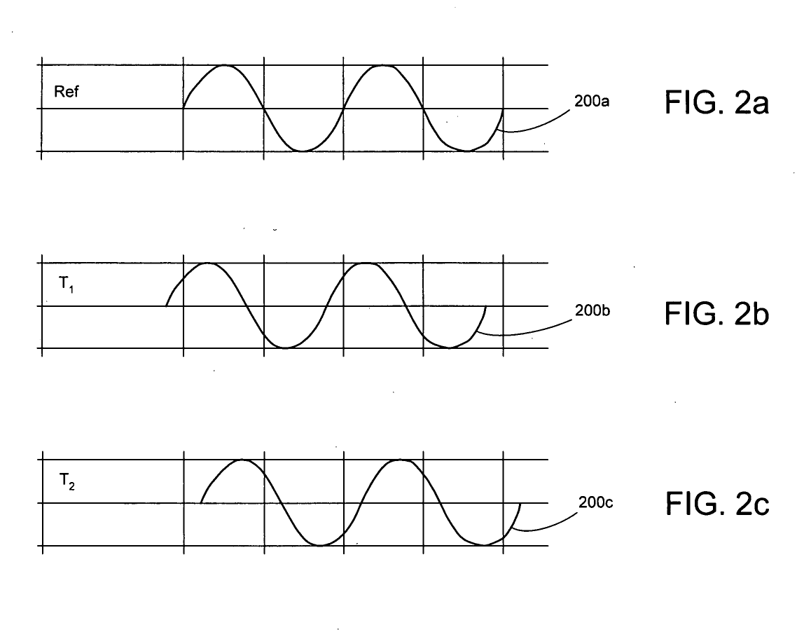

As mentioned previously, the signal generated by the source 108 acts as a reference signal for the upstream and downstream acoustic transducers T1 113 and T2 114. FIG. 2a depicts the reference signal 200a generated by source 108 of FIG. 1. FIGS. 2b and 2c depict the acoustic wave signals, 200b and 200c respectively, after undergoing signal processing at the outputs of gain control amplifiers 115 and 116 of FIG. 1, respectively.

In one embodiment, the photo-acoustic pulse flow meter of the present invention is utilized to non-invasively monitor the rate of flow of fluids in a dialysis system such as a hemodialysis, hemofiltration and/or a hemodiafiltration system known to persons of ordinary skill in the art. The fluids for which flow rate measurement during dialysis is required are primarily blood and dialysate, in blood and dialysate circuits respectively; however one of ordinary skill in the art would appreciate that flow rate of other fluids such as infusate or concentrate may also be measured with the flow meter of the present invention. Persons of ordinary skill in the art would also appreciate that the flow meter of the present invention is also capable of indicating when there is a non-flow of fluid in a conduit/passageway.

Thus, referring back to FIG. 1, if the difference between signal outputs of low pass filters 121 and 122 is null, this would imply that there is no flow of fluid. In a dialysis system application, this detection of non-flow of fluid is very useful, as it might be indicative of a serious problem such as the disconnection of an arterial/venous catheter connected to the patient.

Hereinbefore has been disclosed a system and method of non-invasively measuring the rate of flow of fluid passing through a passageway using a photo-acoustic flow meter of the present invention. It will be understood that various changes in the details, arrangement of elements and operating conditions which have been herein described and illustrated in order to explain the nature of the invention may be made by those skilled in the art without departing from the principles and scope of the invention. Therefore, the present examples and embodiments are to be considered as illustrative and not restrictive, and the invention may be modified within the scope of the appended claims.

We claim:

1. A method for measuring the flow of a fluid during dialysis, the method comprising:
projecting an optical beam into said fluid wherein said fluid flows through a fluid pathway in a disposable manifold;
detecting the resultant acoustic signal at a first point upstream and at a second point downstream in the fluid;
determining the phase difference between said acoustic signal detected upstream and said acoustic signal detected downstream in the fluid; and
computing the rate of flow of said fluid from said determined phase difference.

2. The method of claim 1, wherein said fluid is blood.

3. The method of claim 1, wherein said fluid is dialysate.

4. The method of claim 1, wherein said optical beam is generated by a laser system.

5. The method of claim 1, wherein said optical beam is projected perpendicular to the direction of flow of said fluid.

6. The method of claim 1, wherein said phase difference is determined by subjecting to subtraction the signals representative of said acoustic signal phase detected upstream and downstream.

7. The method of claim 1, wherein renal dialysis includes any one or a combination of hemodialysis, hemofiltration and hemodiafiltration.

8. A photo-acoustic flow meter for measuring the flow of a fluid during dialysis, the photo-acoustic flow meter comprising:
a fluid pathway having a transparent section therein;
an optical system for projecting an optical beam into said fluid, wherein said fluid flows through said fluid pathway and wherein the optical beam is projected through said transparent section;
a first acoustic detector for detecting the acoustic signal at a first point upstream from said transparent section;
a second acoustic detector for detecting said acoustic signal at a second point downstream from said transparent section;
means for determining the phase difference between said acoustic signal detected upstream and said acoustic signal detected downstream; and
means for computing the rate of flow of said fluid from the determined phase difference.

9. The photo-acoustic flow meter of claim 9, wherein said means for determining the phase difference comprises a subtraction unit.

10. The photo-acoustic flow meter of claim 9, wherein said optical system is a pulsed laser system.

11. The photo-acoustic pulse flow meter of claim 9, wherein said optical beam is projected perpendicular to the direction of flow of said fluid.

12. The photo-acoustic flow meter of claim 9, wherein said fluid is blood.

13. The photo-acoustic flow meter of claim 9, wherein said fluid is dialysate.

14. The photo-acoustic flow meter of claim 1, wherein renal dialysis includes any one or a combination of hemodialysis, hemofiltration and hemodiafiltration.
